(19) United States
(12) Patent Application Publication
(10) Pub. No.: US 2026/0180460 A1
(43) Pub. Date: Jun. 25, 2026

(54) Method for Operating a DC-To-DC Converter With a Primary Full-Bridge Rectifier and a Secondary Synchronous Rectifier for a Motor Vehicle, Computer Program, Data Processing Device, and Motor Vehicle

(71) Applicant: Bayerische Motoren Werke Aktiengesellschaft, Muenchen (DE)

(72) Inventors: Martin BAUMANN, Muenchen (DE); Bert HAJ ALI, Muenchen (DE)

(21) Appl. No.: 19/127,494

(22) PCT Filed: Oct. 26, 2023
(86) PCT No.: PCT/EP2023/079862

§ 371 Date: May 6, 2025

(30) Foreign Application Priority Data
Nov. 7, 2022 (DE) 10 2022 129 261.4

(51) Int. Cl. H02M 3/335; H02M 1/08; H02M 3/156; H02M 3/158

(52) U.S. Cl. CPC H02M 3/33592; H02M 1/08; H02M 3/156; H02M 3/1584; H02M 3/1588

(57) ABSTRACT

A method for operating a DC-to-DC converter with a primary full-bridge rectifier and a secondary synchronous rectifier for a motor vehicle includes detecting an input voltage of the synchronous rectifier, an output voltage of the synchronous rectifier, and an output power of the synchronous rectifier; determining a switch event with a falling signal edge per switch element of the DC-to-DC converter and a switch element of the synchronous rectifier; ascertaining a delay of the falling signal edge of the switch element of the synchronous rectifier using the input voltage, the output voltage, and the output power; and outputting a control signal in order to shift the signal edge of the switch element of the synchronous rectifier according to the delay.

### BACKGROUND AND SUMMARY

The present disclosure relates to a method for operating a DC-to-DC converter with a primary full-bridge rectifier and a secondary synchronous rectifier for a motor vehicle, and a data processing device that is configured to perform at least part of the method. Furthermore, a motor vehicle with the data processing device is provided. Additionally or alternatively, a computer program is provided that comprises commands that, when the program is executed by a computer, cause it to execute at least part of the method.

DE 10 2007 001 673 A1 discloses an on-board network system for a motor vehicle comprising a high-voltage energy storage for supply of a high-voltage power network for the power supply of one or more high-voltage consumers and a first converter device for converting the high voltage of the high-voltage power network to a predetermined low voltage of a low-voltage power network for the power supply of one or more low-voltage consumers. A second converter device is also present which is switched in parallel with the first converter device and through which at least part of the time a predetermined energy input flows into the low-voltage power network.

A DC-to-DC converter according to the state of the art has an LC filter as its output stage. Here, a coil decouples a switch element of the synchronous rectifier from condensers and/or capacitances. This can lead to an overshoot of the output voltage (drain-source voltage) of the switching element. This overshoot is due to a resonance of the DC-to-DC converter. Here, a reverse recovery charge (Qrr) of a body diode allocated to the switching element can also further reinforce the overshoot. The voltage during the overshoot leads to an overshoot of the output voltage above a threshold voltage at which the switching element works reliably. The overshoot of the voltage leads to accelerated aging of the switching element.

In the context of this state of the art, an object of the present disclosure is to provide an improved method suitable for enriching the state of the art. A concrete embodiment of the disclosure can achieve the objective of avoiding an overshoot of the output voltage and permit improved operation of the switching element and reduce aging of the switching element.

This objective is achieved by the characteristics disclosed herein, which disclosure also includes optional refinements of the disclosure.

Accordingly, this object is achieved by a method for operating a DC-to-DC converter with a primary full-bridge rectifier and a secondary synchronous rectifier for a motor vehicle, wherein the method comprises: detecting an input voltage of the synchronous rectifier, an output voltage of the synchronous rectifier, and an output power of the synchronous rectifier; determining a switching event with a falling of a signal edge of each of a switching element of the DC-to-DC converter and a switching element of the synchronous rectifier; calculating a delay in the falling of the signal edge of the switching element of the synchronous rectifier based on the input voltage, the output voltage, and the output power; and emitting a control signal to postpone the signal edge of the switching element of the synchronous rectifier in accordance with the delay.

It has herein been recognized that the DC-to-DC converter without a suitable control of the switching element leads to an excessive overshoot of a voltage of the switching element of the synchronous rectifier. To make reduction of the overshoot possible, an adaptation of a logical switching signal is used to control the switching of the switching element of the synchronous rectifier. There can thus be a postponement of the signal edge of the switching element of the synchronous rectifier with respect to the signal edge of a switching element of the full-bridge rectifier. In other words, the falling of the signal edge of the switching element of the synchronous rectifier takes place later than the falling of the signal edge of the switching element of the full-bridge rectifier. Here, it was recognized that the period defined by the delay between the falling signal edge of the switching element of the full-bridge rectifier and the falling signal edge of the switching element of the synchronous rectifier can results in a reduction in the current through the switching element of the synchronous rectifier.

The method has the advantage that the drop in current can avoid or reduce the reverse recovery charge, can reduce the overshoot of the voltage, and therefore can counter the premature aging of the switching element of the synchronous rectifier.

The calculation of the delay can be carried out based on a linear equation dependent on the input voltage, the output voltage, and the output power. In other words, the delay is calculated based on a linearized model with three variables, the input voltage, the output voltage, and the output power. The linearized model can be computed efficiently and takes the variables into consideration that are relevant for the delay and prevention of the overshoot. In other words, the equation of the delay has the form t=a*iV+b*oV+c*oP, where t is the delay, iV is the input voltage, oV is the output voltage, oP is the output power, and with coefficients a, b, and c.

The calculation of the delay can be carried out based on a simulation of the DC-to-DC converter. In particular, a non-linear relationship between the capacitances of the synchronous rectifier (Coss) can be modeled for the simulation. Here, a functional model of the capacitances of the synchronous rectifier can be carried out on the basis of data points, for example from a datasheet, for the capacitances of the synchronous rectifier by a fit of a non-linear function to the data points. The non-linear function can be used for modeling and simulation of the DC-to-DC converter in order to model the oscillatory behavior and in particular the overshoot effectively.

The simulation can model the DC-to-DC converter for an interval of each of the input voltage, the output voltage, and the output power. Here, the simulation can model the DC-to-DC converter for typical working points.

The simulation can model the DC-to-DC converter in a non-interrupting mode (current conduction mode or continuous current mode, CCM). The DC-to-DC converter can thus be modeled in a scenario in which the output current of the DC-to-DC converter is never zero, in order to model a DC voltage effectively.

The calculation of the delay can be carried out in such a way that reduction of a switching current associated with the switching element of the synchronous rectifier below a threshold and/or to 0 A. It can thus be ensured that the switching current is reduced to the point that no, or an insignificant, reverse recovery charge contributing to excessive aging occurs, thus avoiding excessive overshoot.

The switching even can be defined by a pulse width modulation. This allows the switching events to be controlled effectively. Defining the switching events using pulse width modulation, makes the effective calculation of the switching events possible.

Further, a computer program is provided, comprising commands that, when the program is executed by a computer, cause it to execute and/or perform at least part of the method described above.

A program code of the computer program can be available in an arbitrary code, in particular in a code that is suitable for controllers of motor vehicles.

The descriptions above related to the method apply analogously to the computer program, and vice versa.

Further, a data processing device, for example a control unit, for an automated motor vehicle is provided, wherein the data processing device is configured to execute and/or perform at least part of the method described above. The method is thus a computer-implemented method.

The data processing device can be part of a driver assistance system or represent such a system. The data processing device can for example be an electronic control unit (ECU). The electronic control unit can be an intelligence processor-controlled unit that for example can communicate through a Central Gateway (GCW) with other modules and that can make up a vehicle on-board network by fieldbuses such as CAN-Bus, LIN-Bus, MOST-Bus, and FlexRay or using Automotive Ethernet, for example together with telematics control units.

The descriptions above related to the method and to the computer program apply analogously to the data processing device, and vice versa.

Further, a motor vehicle is provided, comprising the data processing device described above.

The motor vehicle can be personal vehicle, in particular an automobile. The optionally automated motor vehicle can be an electrically powered motor vehicle. The motor vehicle can have an electric drive for this purpose, to which electrical energy can be applied by the energy storage system in order to drive the motor vehicle.

The optionally automated motor vehicle can be configured to assume longitudinal and/or lateral control in an automated driving of the motor vehicle, at least partly and/or at least part of the time. The automated driving can be carried out in such a way that the forward movement of the motor vehicle takes place (largely) autonomously. The automated driving can be controlled at least partly and/or part of the time by the data processing device. The motor vehicle can be a motor vehicle of autonomy class 0 through 5.

The descriptions above related to the method, the data processing device, and the computer program, apply analogously to the motor vehicle, and vice versa.

Further, a computer-readable medium, in particular a computer-readable storage medium, is provided. The computer-readable medium comprises commands that, upon execution of the program by a computer, cause it to carry out at least part of the method described above.

That is, a computer-readable medium can be provided that comprises a computer program as defined above. The computer-readable medium can be any arbitrary digital data storage device, such as for example a USB stick, a hard drive, a CD-ROM, an SD card, or an SSD card. The computer program need not necessarily be stored on such a computer-readable storage medium in order to be provided to the motor vehicle, but can also be obtained externally through the Internet or other sources.

The descriptions above related to the method, the data processing device, the computer program, and the automated motor vehicle apply analogously to the computer-readable medium, and vice versa.

An embodiment is described below with reference to the figures.

### BRIEF DESCRIPTION OF THE DRAWINGS

FIG. 1 shows a schematic view of a motor vehicle according to an aspect of the disclosure;

FIG. 2 shows a DC-to-DC converter for a motor vehicle according to an aspect of the disclosure;

FIG. 3 shows a scheme for the switching of switching elements of a DC-to-DC converter for a motor vehicle according to an aspect of the disclosure;

FIG. 4 shows a schematic view of a voltage, a current, and a switching signal depending on the time of a switching element of a synchronous rectifier according to the state of the art;

FIG. 5 shows a schematic view of a voltage, a current, and a switching signal of a switching element depending on the time of a switching element of a synchronous rectifier of a DC-to-DC converter for a motor vehicle according to an aspect of the disclosure; and

FIG. 6 shows a schematic view of a flowchart of a method according to an aspect of the disclosure.

### DETAILED DESCRIPTION OF THE DRAWINGS

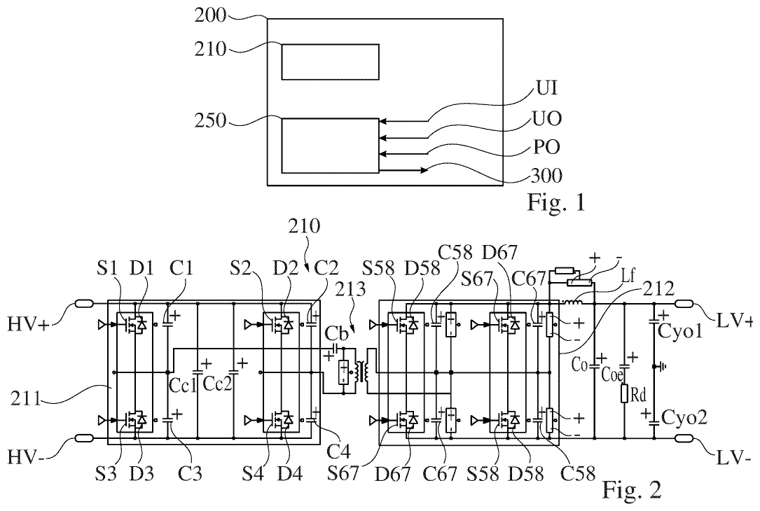

FIG. 1 shows a schematic view of a motor vehicle 200 according to an aspect of the disclosure. The motor vehicle 200 is for example a hybrid vehicle and/or an electric vehicle. The motor vehicle 200 has a traction battery (not shown) as a high-voltage energy storage system. The motor vehicle 200 further has a low-voltage power network (not shown), for example an on-board network. For the low-voltage power network to be supplied with electrical energy from the high-voltage energy storage and operated, the motor vehicle comprises a DC-to-DC converter 210 and a data processing device 250. The DC-to-DC converter 210 is configured to convert a high voltage HV+, HV− into a low voltage LV+, LV−. The data processing device 250 is configured for the control and/or regulation of the DC-to-DC converter 210. The data processing device 250 is configured to execute the method 100 described with reference to FIG. 6. To this end, the data processing device 250 is configured to determine an input voltage UI, an output voltage UO, and an output power PO by measurement, to define a switching event 300 by pulse width modulation, and to request the output of a corresponding control signal. The DC-to-DC converter is described in more detail with reference to FIGS. 2, 3, and 5.

FIG. 2 shows a DC-to-DC converter 210 for a motor vehicle 200 according to an aspect of the disclosure. Such a motor vehicle 200 is described with reference to FIG. 1.

The DC-to-DC converter 210 according to FIG. 2 comprises a primary full-bridge rectifier 211 and a secondary synchronous rectifier 212. The full-bridge rectifier 211 is configured to be supplied with a high voltage HV+, HV− and has four switching elements S1, S2, S3, S4. Each of the switching elements S1, S2, S3, S4 is designed as a MOSFET and connected in parallel with a body diode D1, D2, D3, D4. Each of the switching elements S1, S2, S3, S4 has a condenser C1, C2, C3, C4 as an output stage.

The full-bridge rectifier 211 and the synchronous rectifier 212 are coupled together through an oscillation circuit 213.

The synchronous rectifier 212 is configured to provide a low voltage LV+, LV− and has four switching elements S58, S67. Each of the switching elements S58, S67 is designed as a MOSFET and connected in parallel with a body diode D58, D67. Each of the switching elements S58, S67 has a condenser C58, C67 as an output stage.

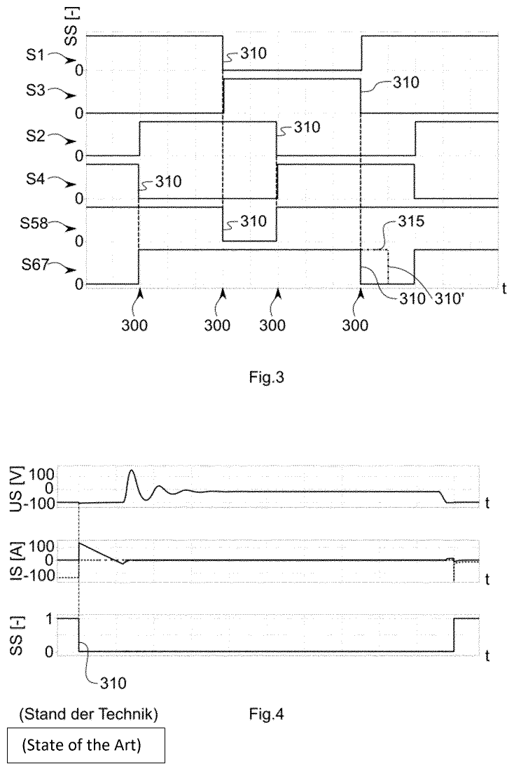

The switching elements S1, S2, S3, S4, S58, S67 are switched by a switching signal SS. The switching of switching elements S1, S2, S3, S4, S58, S67 is therefore controlled by data processing device 250. To do this, the data processing device 250 applies a switching signal SS defined by pulse width modulation to the switching elements S1, S2, S3, S4, S58, S67. A scheme for switching the switching elements S1, S2, S3, S4, S58, S67 according to such a signal is shown in FIG. 3.

FIG. 3 shows a scheme for switching the switching elements S1, S2, S3, S4, S58, S67 of a DC-to-DC converter 210 for a motor vehicle 200 according to an aspect of the disclosure. FIG. 3 is described with reference to FIGS. 1 and 2.

In particular, FIG. 3 shows a switching signal SS for switching the switching elements S1, S2, S3, S4, S58, S67 depending on time t. Here, the switching signal SS is graphed in an arbitrary unit and the switching signals SS of the switching elements S1, S2, S3, S4, S58, S67 are graphed one above the other, whereby the switching SS for one of the switching elements S1, S2, S3, S4, S58, S67 is illustrated with a zero line marked “0” as reference and for orientation.

The switching signal SS comprises a multiplicity of switching events 300. On each of the switching events 300, the switching signal SS of one of the switching elements S1, S2, S3, S4, S58, S67 changes rapidly. In particular, a switching can comprise a falling of a signal edge 310 to the zero line.

The vertically arranged dotted lines illustrated that according to the state of the art a switching of one of the switching elements S1, S2, S3, S4 of the full-bridge rectifier 311 and one of the switching elements S58, S67 of the synchronous rectifier 312 takes place simultaneously. There is thus no dead time (delay) between a switching of one of the switching elements S1, S2, S3, S4 of the full-bridge rectifier 311 and a falling of a signal edge 310 in a switching of one of the switching elements S58, S67 of the synchronous rectifier 312.

The simultaneous switching of one of the switching elements S1, S2, S3, S4 of the full-bridge rectifier 311 and one of the switching elements S58, S67 of the synchronous rectifier 312, results in the relationships described with reference to FIG. 4 between a voltage US, a current IS, and a switching signal SS as a dependency on time.

FIG. 4 shows a schematic view of a voltage US, a current IS, and a switching signal SS, depending on time, of a switching element S58, S67 and/or of a body diode D58, D59 connected in parallel to the switching element S58, S67 of a synchronous rectifier 311 according to the state of the art.

The switching signal SS (gate signal or PWM signal) illustrates a switching of the switching element S58, S67. At a switching point defining the switching and indicated by a vertical dotted line, there occurs a falling of a signal edge 310. Before the switching, a negative current IS (MOSFET current, solid line) flows through the switching element S58, S67. On switching, the current IS through the switching element S58, S67 goes to zero and the current IS is instead directed through the body diode D58, D67 (freewheeling, body diode current, dotted line). The current IS flowing through the body diode D58, D67 causes a reverse recovery charge (RRC) when the current IS reaches zero. The reverse recovery charge causes an overshoot and decaying oscillation of the voltage US (drain-source voltage) of the switching element S58, S67 (drain-source voltage). Furthermore, this causes further losses in the DC-to-DC converter 210 due to a voltage drop at the body diodes D58, D67.

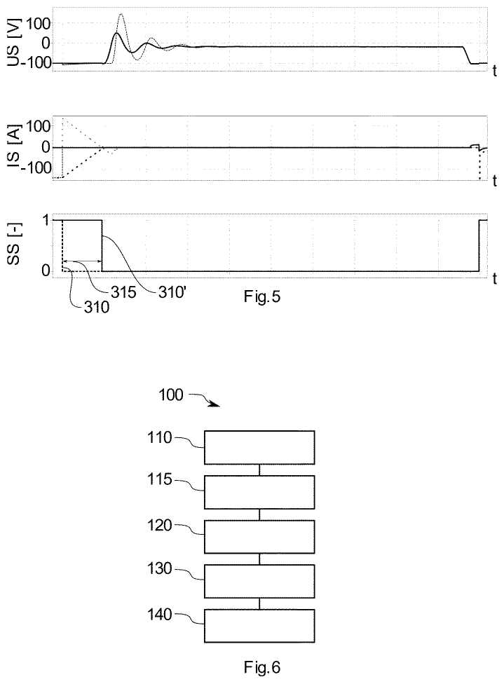

FIG. 5 shows a schematic view of a voltage, a current, and a switching signal depending on time, of a switching element S58, S67 of a synchronous rectifier 311 of a DC-to-DC converter 210 for a motor vehicle 200 according to an aspect of the disclosure. FIG. 5 is described with reference to FIGS. 1 through 4. In particular the difference between FIGS. 4 and 5 are described.

The switching signal SS (gate signal, PWM signal) illustrates a switching of the switching element S58, S67. The switching signal SS described with reference to FIG. 4 is shown in FIG. 5 with a dashed line (“PWM Signal: Typical”) and a switching signal SS according to the method 100 according to an aspect of the disclosure is shown with a solid line (“PWM Signal: Adapted”). The switching signals SS differ in the falling of the signal edge 310, 310′. The falling of the signal edge 310 according to the state of the art is specifically postponed by a delay 315 in order to achieve the falling of the signal edge 310′ according to the method 100 according to an aspect of the disclosure.

The delay 315 is also illustrated in FIG. 3 by a dotted line. It can be seen that the switching of the primary full-bridge rectifier 311 remains unchanged and only the switching of a switching element S58, S67 of the synchronous rectifier 312 on switching off is postponed according to the delay 315 with respect to the switching of the switching elements S1, S2, S3, S4 of the full-bridge rectifier 311.

As shown in FIG. 5, the current IS sinks to zero by the falling of the signal edge 310′. A freewheeling of the diode D58, D67 and the buildup of a reverse recovery charge (RRC) is avoided. The current IS in FIG. 5 described with reference to FIG. 4 is shown with a light dotted line (“Body Diode Current: Typical”) and with a heavy dotted line (“MOSFET Current: Typical”) and a current IS according to the method 100 according to an aspect of the disclosure is shown with a solid line (“Body Diode Current: Adapted”) and with a dashed line (“MOSFET Current: Adapted”). An overshoot of the voltage US of the switching element S58, S67 (“Drain-Source-Voltage: Adapted”, solid line) can be reduced by 40% with respect to the state of the art (“Drain-Source-Voltage: Typical”, dotted line). Furthermore, further losses in the DC-to-DC converter 210 due to a voltage drop at the body diodes D58, D67 can be prevented.

FIG. 6 shows a schematic view of a flowchart of a method 100 according to an aspect of the disclosure. The method 100 is a method 100 for operating a DC-to-DC converter 210 with a primary full-bridge rectifier 211 and a secondary synchronous rectifier 212 for a motor vehicle 200. Such a motor vehicle 200 is described with reference to FIG. 1. Such a DC-to-DC converter 210 is described with reference to FIG. 2.

The method 100 according to FIG. 6 has: detection 110 of an input voltage UI of the synchronous rectifier 212, an output voltage UO of the synchronous rectifier 212, and an output power PO of the synchronous rectifier 212. The detection 110 of the input voltage UI, the output voltage UO, and the output power PO can take place by measurement using a measurement device (not shown) connected to the data processing device 250 (see FIG. 1).

There follows a determination 120 of a switching event 300 with a falling of a signal edge 310 of each of a switching element S3 of the DC-to-DC converter 210 and a switching element S67 of the synchronous rectifier 212. The switching event 300 is defined with a pulse width modulation. The determination 120 of the switching even 300 by pulse width modulation can thus be determined by the data processing device 250.

There follows a calculation 130 of a delay 315 in the falling of the signal edge 310 of the switching element S67 of the synchronous rectifier 212 based on the input voltage UI, the output voltage UO, and the output power PO. The calculation 130 of the delay 315 is carried out based on a simulation of the DC-to-DC converter 210. Here, the DC-to-DC converter 210 is simulated in a working range. To this end, the simulation models the DC-to-DC converter 210 for an interval of each of the input voltage UI, the output voltage UO, and the output power PO. The simulation models the DC-to-DC converter 210 in a continuous operation, that is, in an operation in which the DC-to-DC converter 210 emits a voltage at all times. The calculation 130 of the delay 315 is carried out based on a linear equation depending on each of the input voltage UI, the output voltage UO, and the output power PO. The calculation 130 of the delay 315 is carried out in such a way that a reduction of a switching current IS of the switching element 67 of the synchronous rectifier 322 occurs below a threshold and/or to 0 A. For this, the three variables input voltage UI, output voltage UO, and output power PO are optimized with respect to the reduction of the switching current IS in order to reach a local or global minimum of the switching current IS depending on the input voltage UI, the output voltage UO, and the output power PO with delay 315. The calculation 130 of the delay 3415 is performed by the data processing device 250.

There follows an output 140 of a control signal to postpone the signal edge 310′ of the switching element S67 of the synchronous rectifier 212 in accordance with delay 315.

For this purpose, the data processing device 250 emits a correspondingly adapted switching signal SS in order to adjust switching events 300 of the synchronous rectifier 212 and delay them with respect to switching events 300 of the full-bridge rectifier 211.

List of reference numbers

| | |
|---|---|
| 100 | Method |
| 110 | Determination of an input voltage, an |
| | output voltage, and an output power |
| 120 | Determination of a switching event |
| 130 | Calculation of a delay |
| 140 | Emitting of a control signal |
| 200 | Motor vehicle |
| 210 | DC-to-DC converter |
| 211 | Full-bridge rectifier |
| 212 | Synchronous rectifier |
| 213 | Oscillatory circuit |
| 250 | Data processing device |
| 300 | Switching event |
| 310 | Signal edge |
| 310′ | Signal edge |
| 315 | Delay |
| C1, C2, C3, | Capacitance |
| C4, C58, C67 | |
| D1, D2, D3, | Body diode |
| D4, D58, D67 | |
| IS | Current of a switching element |
| | of the synchronous rectifier |
| LV+, LV− | Low voltage |
| HV+, HV− | High voltage |
| PO | Output power |
| S1, S2, S3, | Switching element |
| S4, S58, S67 | |
| t | Time |
| UI | Input voltage |
| US | Voltage of a switching element |
| | of the synchronous rectifier |
| UO | Output voltage |

1-10. (canceled)

11. A method for operating a DC-to-DC converter having a primary full-bridge rectifier and a secondary synchronous rectifier for a motor vehicle, the method comprising:
detecting an input voltage of the synchronous rectifier, an output voltage of the synchronous rectifier, and an output power of the synchronous rectifier;
determining a switching event with a falling of a signal edge of each of a switching element of the DC-to-DC converter and a switching element of the synchronous rectifier;
calculating a delay of the falling of the signal edge of the switching element of the synchronous rectifier based on the input voltage, the output voltage, and the output power; and
emitting a control signal to postpone the signal edge of the switching element of the synchronous rectifier according to the delay.

12. The method according to claim 11, comprising:
calculating the delay based on a linear equation depending on each of the input voltage, the output voltage, and the output power.

13. The method according to claim 11, comprising:
calculating the delay based on a simulation of the DC-to-DC converter.

14. The method according to claim 13,
wherein the simulation models the DC-to-DC converter for an interval of each of the input voltage, the output voltage, and the output power.

15. The method according to claim 13,
wherein the simulation models the DC-to-DC converter in a continuous operation.

16. The method according to claim 11, comprising:
calculating the delay so that a reduction of a switching current affecting the switching element of the synchronous rectifier is below a threshold and/or is to 0 A.

17. The method according to claim 11,
wherein the switching event is defined by a pulse width modulation.

18. A non-transitory computer-readable medium having stored thereon commands that, upon execution by a computer, cause the computer to execute the method according to claim 11.

19. A data processing device for a motor vehicle, comprising:
at least one processing device configured to:
detect an input voltage of a secondary synchronous rectifier of a DC-to-DC converter, an output voltage of the synchronous rectifier, and an output power of the synchronous rectifier, wherein the DC-to-DC converter also includes a primary full-bridge rectifier;
determine a switching event with a falling of a signal edge of each of a switching element of the DC-to-DC converter and a switching element of the synchronous rectifier;
calculate a delay of the falling of the signal edge of the switching element of the synchronous rectifier based on the input voltage, the output voltage, and the output power; and
emit a control signal to postpone the signal edge of the switching element of the synchronous rectifier according to the delay.

20. The data processing device according to claim 19,
wherein the at least one processing device is configured to:
calculate the delay based on a linear equation depending on each of the input voltage, the output voltage, and the output power.

21. The data processing device according to claim 19,
wherein the at least one processing device is configured to:
calculate the delay based on a simulation of the DC-to-DC converter.

22. The data processing device according to claim 21,
wherein the simulation models the DC-to-DC converter for an interval of each of the input voltage, the output voltage, and the output power.

23. The data processing device according to claim 21,
wherein the simulation models the DC-to-DC converter in a continuous operation.

24. The data processing device according to claim 19,
wherein the at least one processing device is configured to:
calculate the delay so that a reduction of a switching current affecting the switching selement of the synchronous rectifier is below a threshold and/or is to 0 A.

25. The data processing device according to claim 19,
wherein the switching event is defined by a pulse width modulation.

26. A motor vehicle, comprising:
the data processing device according to claim 19.
